(19) United States
(12) Patent Application Publication
(10) Pub. No.: US 2011/0179872 A1
(43) Pub. Date: Jul. 28, 2011

(54) DRIVE CIRCUIT AND PHYSICAL QUANTITY SENSOR DEVICE

(75) Inventors: Yoichi Kaino, Osaka (JP); Motonori Taniguchi, Kyoto (JP); Fumihito Inukai, Kyoto (JP)

(73) Assignee: PANASONIC CORPORATION, Osaka (JP)

(21) Appl. No.: 13/052,855

(22) Filed: Mar. 21, 2011

Related U.S. Application Data
(63) Continuation of application No. PCT/JP2009/002688, filed on Jun. 12, 2009.

(30) Foreign Application Priority Data
Jan. 22, 2009 (JP) 2009-012303

(51) Int. Cl. G01H 17/00

(52) U.S. Cl. 73/579

(57) ABSTRACT

An amplitude detection circuit detects the amplitude value of a monitor signal responsive to self-excited vibration of a physical quantity sensor. A waveform shaping circuit converts the monitor signal to a pulse signal. A pulse amplitude modulation circuit adjusts the amplitude of the pulse signal according to the amplitude value obtained by the amplitude detection circuit and outputs the result as a drive signal for control of the self-excited vibration of the physical quantity sensor.

### CROSS-REFERENCE TO RELATED APPLICATION

This is a continuation of PCT International Application PCT/JP2009/002688 filed on Jun. 12, 2009, which claims priority to Japanese Patent Application No. 2009-012303 filed on Jan. 22, 2009. The disclosures of these applications including the specifications, the drawings, and the claims are hereby incorporated by reference in their entirety.

### BACKGROUND

The present disclosure relates to a drive circuit for driving a physical quantity sensor that outputs a sensor signal according to a physical quantity given externally, and a physical quantity sensor device including the same, and more particularly to a technique of controlling self-excited vibration of a physical quantity sensor.

Conventionally, physical quantity sensors capable of detecting a physical quantity (e.g., an angular velocity, an acceleration, etc.) are used in a variety of technical fields such as detection of shake of a digital camera, attitude control of a mobile unit (e.g., an aircraft, an automobile, a vessel, a robot, etc.), and guidance of a missile and a spacecraft.

As an example of such physical quantity sensors, there is known a physical quantity sensor that vibrates from self-excitation to output a sensor signal according to a physical quantity given externally. Such a physical quantity sensor vibrates from self-excitation by application of a drive signal from a drive circuit and outputs a monitor signal responsive to the self-excited vibration to the drive signal. The sensitivity of the physical quantity sensor varies with the vibration velocity thereof. Therefore, for stabilization of the sensitivity of the physical quantity sensor, it is important to keep the vibration velocity thereof constant. For this reason, a conventional drive circuit includes a full-wave rectification circuit that rectifies the full wave of the monitor signal and a gain control circuit that amplifies or attenuates the monitor signal with an amplification gain corresponding to the output of the full-wave rectification circuit and outputs the resultant signal as the drive signal (see Japanese Patent Publication No. H11-44540, for example). With this drive circuit, the drive signal is controlled so that the amplitude of the monitor signal is kept constant, whereby the vibration velocity of the physical quantity sensor is stabilized.

### SUMMARY

However, in the conventional drive circuit, since the gain control circuit is constituted by an analog circuit, the amplification gain of the gain control circuit varies with fluctuations in power supply voltage and changes in temperature. Therefore, with an inability to keep the vibration velocity of the physical quantity sensor constant, it is difficult to stabilize the detection precision of the physical quantity sensor.

It is therefore an object of the present disclosure to provide a drive circuit in which fluctuations in the vibration velocity of a physical quantity sensor can be reduced or suppressed.

According to one aspect of the present invention, the drive circuit is a drive circuit configured to drive a physical quantity sensor that vibrates from self-excitation by application of a drive signal to output a monitor signal responsive to the self-excited vibration and also output a sensor signal according to a physical quantity given externally, the drive circuit including: an amplitude detection circuit configured to detect an amplitude value of the monitor signal; a waveform shaping circuit configured to convert the monitor signal to a pulse signal; and a pulse modulation circuit configured to adjust an amplitude of the pulse signal according to the amplitude value obtained by the amplitude detection circuit and output the result as the drive signal. In this drive circuit, by using the pulse modulated signal generated by the pulse modulation circuit as the drive signal, it is possible to suppress or reduce fluctuations in the vibration velocity of the physical quantity sensor due to fluctuations in power supply voltage and changes in temperature. Thus, the detection precision of the physical quantity sensor can be improved.

Alternatively, the drive circuit may include, in place of the waveform shaping circuit and the pulse modulation circuit described above, a ΔΣ modulation circuit that has an input gain variable according to the amplitude value obtained by the amplitude detection circuit, and performs ΔΣ-modulation on the monitor signal and outputs the result as the drive signal. In this drive circuit, by using the pulse-density modulated signal generated by the ΔΣ modulation circuit as the drive signal, it is possible to suppress or reduce fluctuations in the vibration velocity of the physical quantity sensor due to fluctuations in power supply voltage and changes in temperature. Thus, the detection precision of the physical quantity sensor can be improved. In addition, since the ΔΣ modulation circuit has a gain adjustment function, it is unnecessary to provide a circuit for amplifying or attenuating the monitor signal at a stage preceding the ΔΣ modulation circuit. Thus, the drive circuit can be simplified in configuration and thus reduced in circuit scale.

The above drive circuit may further include an analog filter configured to allow a specific frequency component of the drive signal output from the ΔΣ modulation circuit to pass therethrough. With this configuration, it is possible to suppress or reduce fluctuations in the vibration velocity of the physical quantity sensor due to unnecessary frequency components (e.g., harmonic components). Thus, the detection precision of the physical quantity sensor can be further stabilized.

The ΔΣ modulation circuit may include an operation section having first and second sampling capacitors, configured to sample the monitor signal and hold the result in the first sampling capacitor as a monitor voltage, while sampling one of first and second reference voltages and holding the result in the second sampling capacitor as an operation voltage, and add the operation voltage to the monitor voltage, an integrator having an operational amplifier and a feedback capacitor, configured to integrate the output of the operation section; a comparator configured to digitize the output of the integrator, a selector configured to supply one of the first and second reference voltages to the operation section according to the output of the comparator for sampling, and a controller configured to adjust a capacitance value of at least one capacitor among the first and second sampling capacitors and the feedback capacitor according to the amplitude value obtained by the amplitude detection circuit. By adjusting the capacitance value of at least one capacitor among the first and second sampling capacitors and the feedback capacitor as described above, the input gain of the ΔΣ modulation circuit can be adjusted.

The amplitude detection circuit may include an analog-to-digital conversion circuit configured to convert the monitor signal to a digital monitor signal, and a digital amplitude detection circuit configured to detect an amplitude value of the digital monitor signal obtained by the analog-to-digital conversion circuit. By using a digital circuit for the amplitude detection circuit, it is possible to prevent the detected value from varying due to ripple fluctuations. Thus, fluctuations in the vibration velocity of the physical quantity sensor can be further reduced.

Alternatively, the amplitude detection circuit may include an analog-to-digital conversion circuit configured to convert the monitor signal to a digital monitor signal; a digital amplitude detection circuit configured to repeat the processing of detecting an amplitude value of the digital monitor signal obtained by the analog-to-digital conversion circuit, and an averaging circuit configured to average a plurality of amplitude values obtained by the digital amplitude detection circuit. With this configuration, it is possible to suppress or reduce variations in amplitude value due to frequency jitter in the monitor signal. Thus, the vibration velocity of the physical quantity sensor can be further stabilized.

The sampling frequency of the analog-to-digital conversion circuit may be 16 times or more the frequency of the monitor signal. With this setting, it is possible to suppress or reduce fluctuations in the vibration velocity of the physical quantity sensor due to a shift of the sampling timing.

### BRIEF DESCRIPTION OF THE DRAWINGS

FIG. 1 is a view showing an example configuration of a physical quantity sensor device of the first embodiment.

FIG. 2 is a view showing an example configuration of a pulse amplitude modulation circuit shown in FIG. 1.

FIG. 3 is a signal waveform chart illustrating the operation of a drive circuit shown in FIG. 1.

FIG. 4 is a view showing an example configuration of a physical quantity sensor device of the second embodiment.

FIG. 5 is a view showing an example configuration of a pulse width modulation circuit shown in FIG. 4.

FIG. 6 is a signal waveform chart illustrating the operation of a drive circuit shown in FIG. 4.

FIG. 7 is a view showing an example configuration of a physical quantity sensor device of the third embodiment.

FIG. 8 is a view showing an example configuration of a ΔΣ modulation circuit shown in FIG. 7.

FIG. 9 is a view illustrating a first variation of an amplitude detection circuit.

FIG. 10 is a view illustrating a second variation of the amplitude detection circuit.

FIG. 11 is a signal waveform chart illustrating a sampling frequency.

FIG. 12 is a view showing an example configuration of a phase adjustment circuit.

### DETAILED DESCRIPTION

Preferred embodiments will be described in detail with reference to the drawings. It should be noted that same or similar components are denoted by the same reference characters throughout the drawings, and description thereof will not be repeated.

### First Embodiment

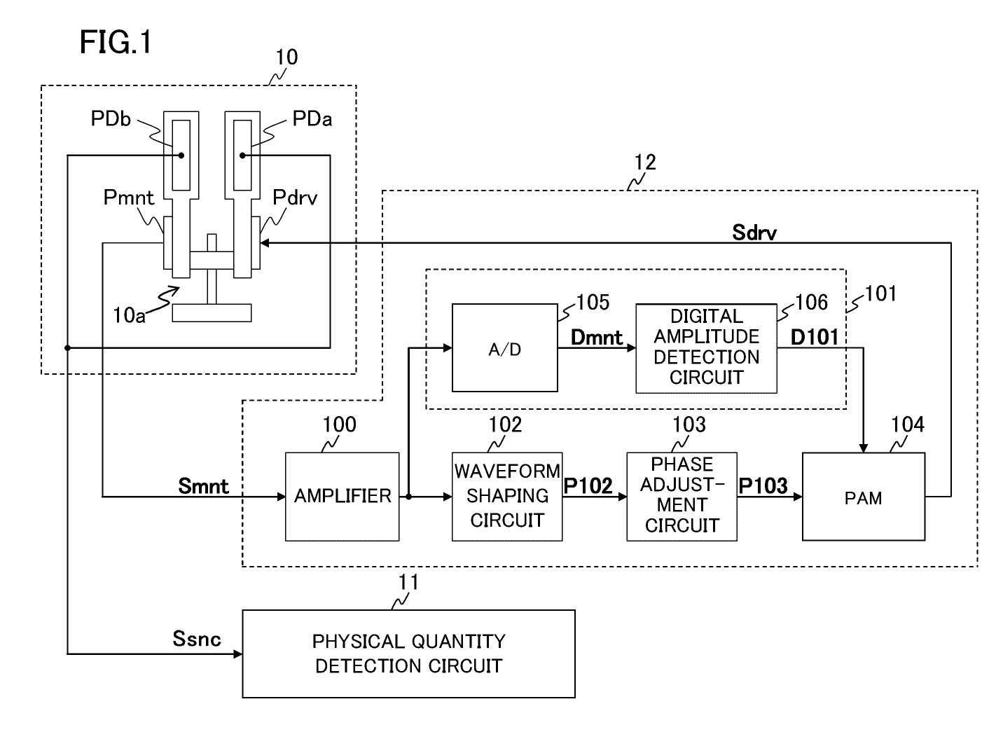

FIG. 1 shows an example configuration of a physical quantity sensor device of the first embodiment. This physical quantity sensor device includes a physical quantity sensor 10, a physical quantity detection circuit 11, and a drive circuit 12.

[Physical Quantity Sensor]

The physical quantity sensor 10 vibrates from self-excitation by application of a drive signal Sdrv and outputs a monitor signal Smnt responsive to the self-excited vibration. Also, the physical quantity sensor 10 outputs a sensor signal Ssnc according to a physical quantity (e.g., an angular velocity, an acceleration, etc.) given externally. In this embodiment, the physical quantity sensor 10 is described as a tuning fork type angular velocity sensor. The physical quantity sensor 10 includes, for example, a tuning fork body 10a, a drive piezoelectric element Pdrv, a monitor piezoelectric element Pmnt, and sensor piezoelectric elements PDa and PDb. The tuning fork body 10a has two prongs each twisted by the right angle in the center, a connection for connecting the two prongs at their ends on one side, and a support pin provided at the connection to serve as a rotation axis. The drive piezoelectric element Pdrv vibrates one prong according to the drive signal Sdrv supplied from the drive circuit 12, and this causes resonance of the two prongs. With this vibration of the tuning fork, charge is generated in the monitor piezoelectric element Pmnt (i.e., the monitor signal Smnt is generated). Also, when a rotational angular velocity (Coriolis force) is generated, an amount of charge corresponding to the rotational angular velocity is generated in the sensor piezoelectric elements PDa and PDb (i.e., the sensor signal Ssnc is generated).

[Physical Quantity Detection Circuit]

The physical quantity detection circuit 11 detects a physical quantity given to the physical quantity sensor 10 based on the sensor signal Ssnc.

[Drive Circuit]

The drive circuit 12 controls the drive signal Sdrv according to the amplitude value of the monitor signal Smnt. The drive circuit 12 includes, for example, an amplifier 100, an amplitude detection circuit 101, a waveform shaping circuit 102, a phase adjustment circuit 103, and a pulse amplitude modulation circuit (PAM) 104.

The amplitude detection circuit 101 detects the amplitude value D101 (digital value) of the monitor signal Smnt. The amplitude detection circuit 101 includes, for example, an analog-to-digital conversion circuit (A/D) 105 that converts the monitor signal Smnt to a digital monitor signal Dmnt and a digital amplitude detection circuit 106 that detects the amplitude value of the digital monitor signal Dmnt and outputs the result as the amplitude value D101. The digital amplitude detection circuit 106 may detect the maximum and minimum values of the digital monitor signal Dmnt and calculate the amplitude value D101 based on the difference therebetween. Otherwise, the digital amplitude detection circuit 106 may shift the phase of the digital monitor signal Dmnt by 90° to obtain a digital phase-shifted signal and calculate the square root of the sum of squares of the digital monitor signal Dmnt and the digital phase-shifted signal as the amplitude value D101.

The waveform shaping circuit 102 converts the monitor signal Smnt to a square wave and outputs the result as a pulse signal P102. The waveform shaping circuit 102 is constituted by a comparator, for example. The phase adjustment circuit 103 adjusts the phase of the pulse signal P102 to ensure synchronization between the drive signal Sdrv and the monitor signal Smnt and outputs the result as a pulse signal P103. The phase adjustment circuit 103 is constituted by a shift register that shifts the pulse signal P102 sequentially, for example.

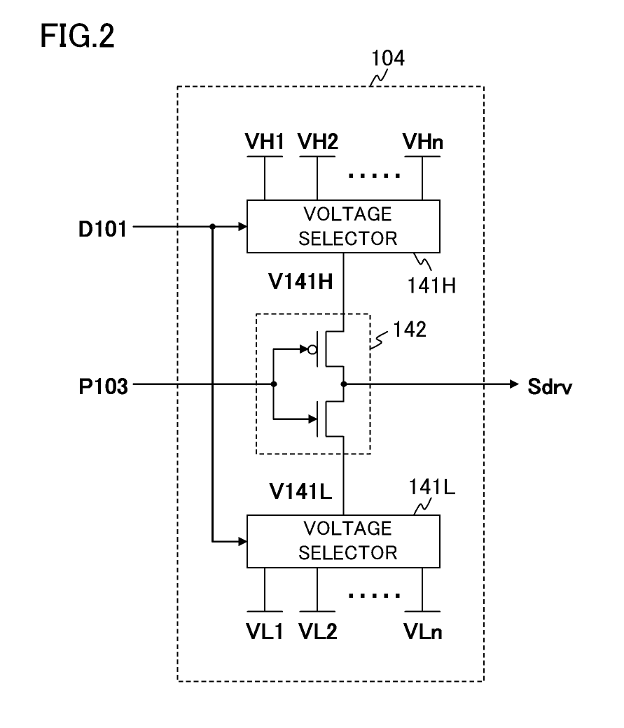

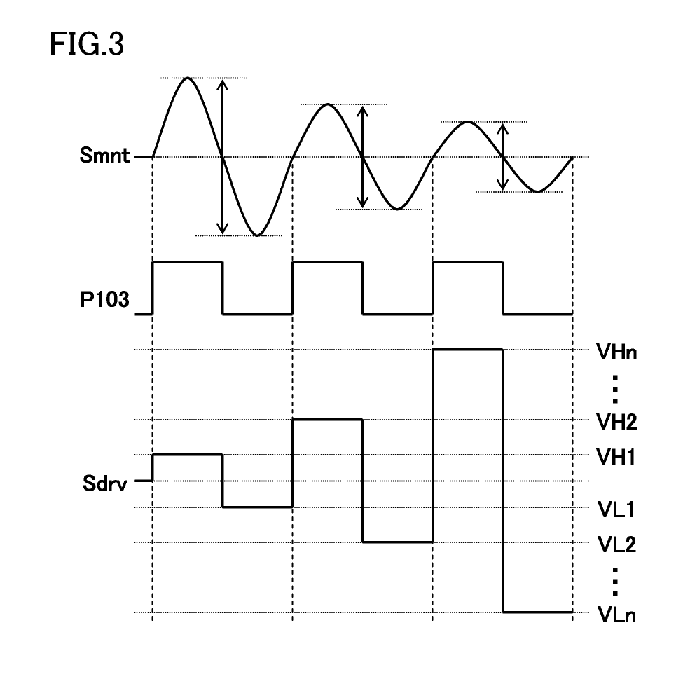

The PAM 104 adjusts the amplitude of the pulse signal P103 according to the amplitude value D101 obtained by the amplitude detection circuit 101 and outputs the result as the drive signal Sdrv. As shown in FIG. 2, the PAM 104 includes voltage selectors 141H and 141L and a switch 142, for example. The voltage selector 141H selects one of n high-level voltages VH1, VH2, . . . , VHn (n is an integer equal to or more than 2) as an upper-limit voltage V141H according to the amplitude value D101 in such a manner that the smaller the amplitude value D101, the higher the upper-limit voltage V141H is. The voltage selector 141L selects one of n low-level voltages VL1, VL2, . . . , VLn as a lower-limit voltage V141L according to the amplitude value D101 in such a manner that the smaller the amplitude value D101, the lower the lower-limit voltage V141L is. The switch 142 outputs the upper-limit voltage V141H and the lower-limit voltage V141L alternately in response to the pulse signal P103. Thus, as shown in FIG. 3, the smaller the amplitude of the monitor signal Smnt, the larger the amplitude of the drive signal Sdrv becomes. The larger the amplitude of the drive signal Sdrv, the higher the vibration velocity of the physical quantity sensor 10 becomes, and as a result, the larger the amplitude of the monitor signal Smnt becomes. In this way, the PAM 104 controls the amplitude of the drive signal Sdrv so that the amplitude of the monitor signal Smnt is kept constant.

Also, in the PAM 104, noise is less likely to occur due to fluctuations in power supply voltage and changes in temperature than in the gain control circuit constituted by an analog circuit. This permits correct control of the amplitude of the drive signal Sdrv. Note that the drive signal Sdrv, which is a pulse signal, includes odd harmonic components (harmonic components whose frequency is an odd multiple of the fundamental frequency). However, since the physical quantity sensor 10 has a high Q value (i.e., has a frequency response characteristic that the gain is larger as the frequency is closer to the fundamental frequency), it hardly responds to odd harmonic components. With this frequency response characteristic, it is possible to suppress or reduce fluctuations in the vibration velocity of the physical quantity sensor 10 due to odd harmonic components.

As described above, by using the pulse-amplitude modulated signal generated by the PAM 104 as the drive signal Sdrv, it is possible to suppress or reduce fluctuations in the vibration velocity of the physical quantity sensor 10 due to fluctuations in power supply voltage and changes in temperature. Thus, the detection precision of the physical quantity sensor 10 can be stabilized.

In the conventional drive circuit, since a ripple is included in the output of the full-wave rectification circuit that corresponds to the amplitude detection circuit, the detected value (the amplitude value of the monitor signal detected by the amplitude detection circuit) varies with ripple fluctuations. As a result, the amplification gain in the gain control circuit varies, resulting in fluctuations in the vibration velocity of the physical quantity sensor 10. However, in this embodiment, in which the amplitude detection circuit is a digital circuit, it is possible to prevent the detected value from varying due to ripple fluctuations. Thus, fluctuations in the vibration velocity of the physical quantity sensor 10 can be further suppressed or reduced.

The phase adjustment circuit 103 may be placed at a stage subsequent to the PAM 104. That is, the phase of the drive signal Sdrv may be adjusted after the generation of the drive signal Sdrv by the PAM 104. The PAM 104 may include only either one of the voltage selectors 141H and 141L. That is, in the PAM 104, one of the upper-limit voltage V141H and the lower-limit voltage V141L may be a fixed value.

### Second Embodiment

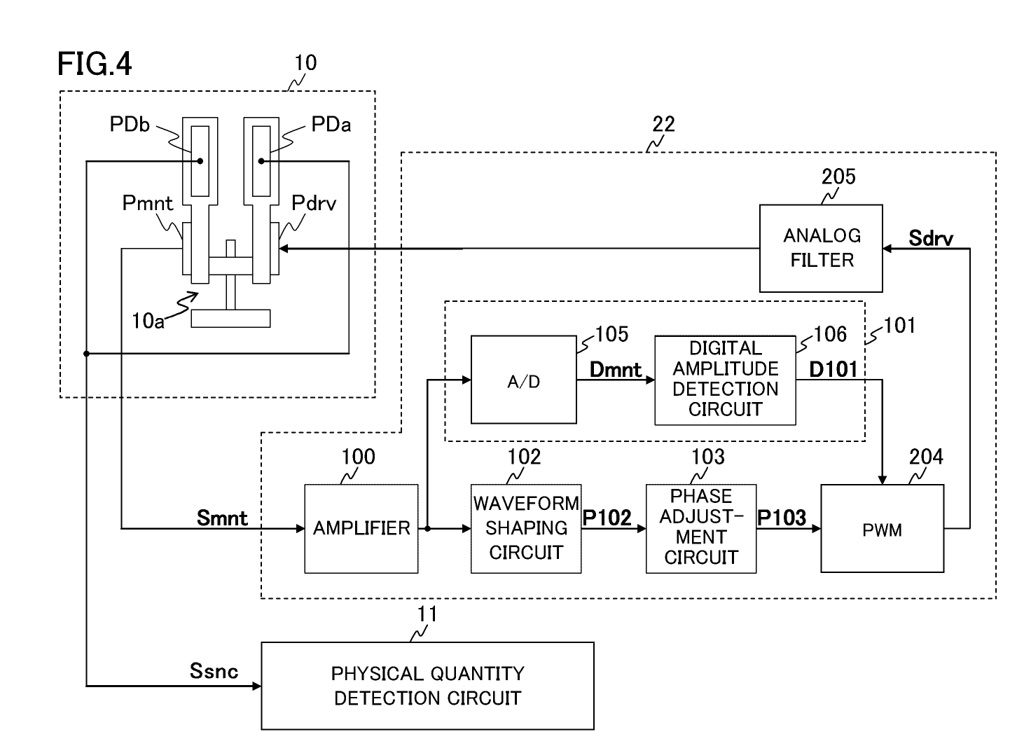

FIG. 4 shows an example configuration of a physical quantity sensor device of the second embodiment. This physical quantity sensor device is the same in configuration as that of FIG. 1 except that a pulse width modulation circuit (PWM) 204 and an analog filter 205 are provided in place of the PAM 104 shown in FIG. 1. The PWM 204 adjusts the pulse width (duty ratio) of the pulse signal P103 according to the amplitude value D101 and outputs the result as the drive signal Sdrv. The analog filter 205 allows a specific frequency component (e.g., a component near the fundamental frequency) of the drive signal Sdrv to pass therethrough while attenuating the other frequency components. In this way, the waveform of the drive signal Sdrv can be brought close to a sine wave. The analog filter 205 is constituted by a band-pass filter, for example.

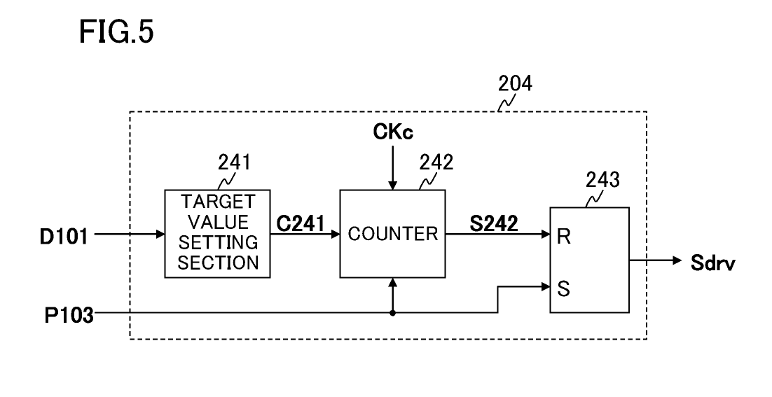

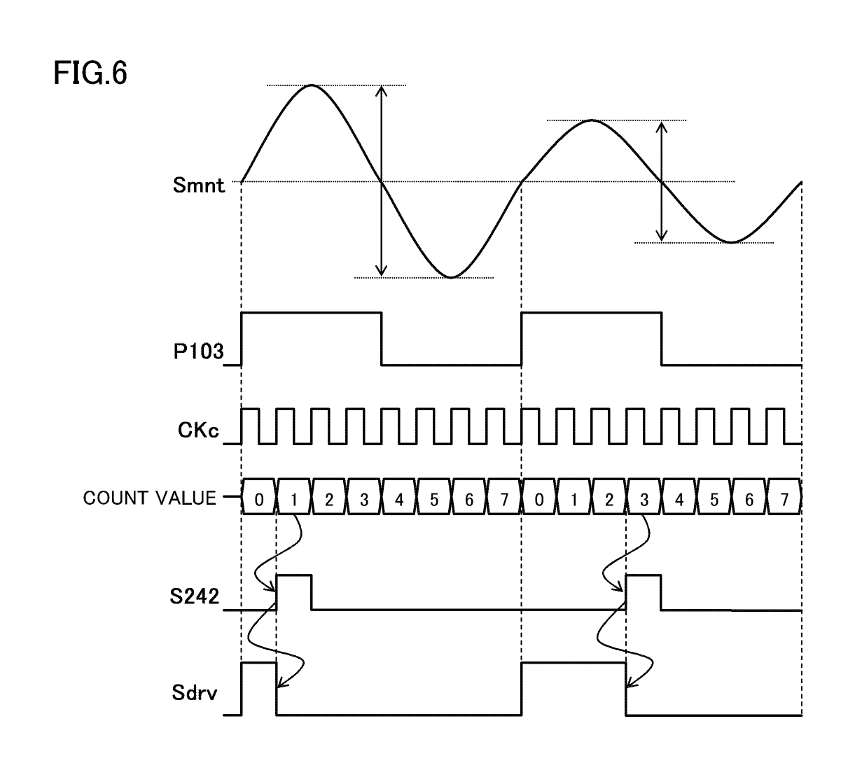

As shown in FIG. 5, the PWM 204 includes a target value setting section 214, a counter 242, and a RS latch 243, for example. The target value setting section 241 sets a target count value C241 according to the amplitude value D101 in such a manner that the smaller the amplitude value D101, the larger the target count value C241 is. The counter 242, operating in synchronization with a clock CKc (e.g., a clock obtained by multiplying the frequency of the pulse signal P103), starts counting in response to transition edges of the pulse signal P103. When the count value reaches the target count value C241, the counter 242 outputs a control signal S242. The RS latch 243 allows the drive signal Sdrv to transition from low to high in response to transition edges of the pulse signal P 103, and to transition from high to low in response to the control signal S242. As shown in FIG. 6, the smaller the amplitude of the monitor signal Smnt, the closer the pulse duty ratio (the proportion of the high-level duration in one period) of the drive signal Sdrv is to 50%. The closer the pulse duty ratio of the drive signal Sdrv to 50%, the higher the vibration velocity of the physical quantity sensor 10 becomes, resulting in increase in the amplitude of the monitor signal Smnt. In this way, the PWM 204 controls the pulse width of the drive signal Sdrv so that the amplitude of the monitor signal Smnt is kept constant.

Also, in the PWM 204, noise is less likely to occur due to fluctuations in power supply voltage and changes in temperature than in the gain control circuit constituted by an analog circuit. This permits correct control of the pulse width of the drive signal Sdrv. Note that the drive signal Sdrv, which is a pulse-width modulated signal, includes harmonic components whose frequency is an integer multiple of the fundamental frequency. However, with the frequency response characteristic of the physical quantity sensor 10, it is possible to suppress or reduce fluctuations in the vibration velocity of the physical quantity sensor 10 due to harmonic components.

As described above, by using the pulse-width modulated signal generated by the PWM 204 as the drive signal Sdrv, it is possible to suppress or reduce fluctuations in the vibration velocity of the physical quantity sensor 10 due to fluctuations in power supply voltage and changes in temperature. Thus, the detection precision of the physical quantity sensor 10 can be stabilized.

Moreover, with the analog filter 205 allowing a specific frequency component to pass therethrough, it is possible to suppress or reduce fluctuations in the vibration velocity of the physical quantity sensor 10 due to unnecessary frequency components (e.g., harmonic components). Thus, the detection precision of the physical quantity sensor 10 can be further stabilized.

The phase adjustment circuit 103 may be placed at a stage subsequent to the PWM 204. That is, the phase of the drive signal Sdrv may be adjusted after the generation of the drive signal Sdrv by the PWM 204. Otherwise, the phase adjustment circuit 103 may be omitted, and the phase of the drive signal Sdrv may be adjusted using the phase characteristic of the analog filter 205.

### Third Embodiment

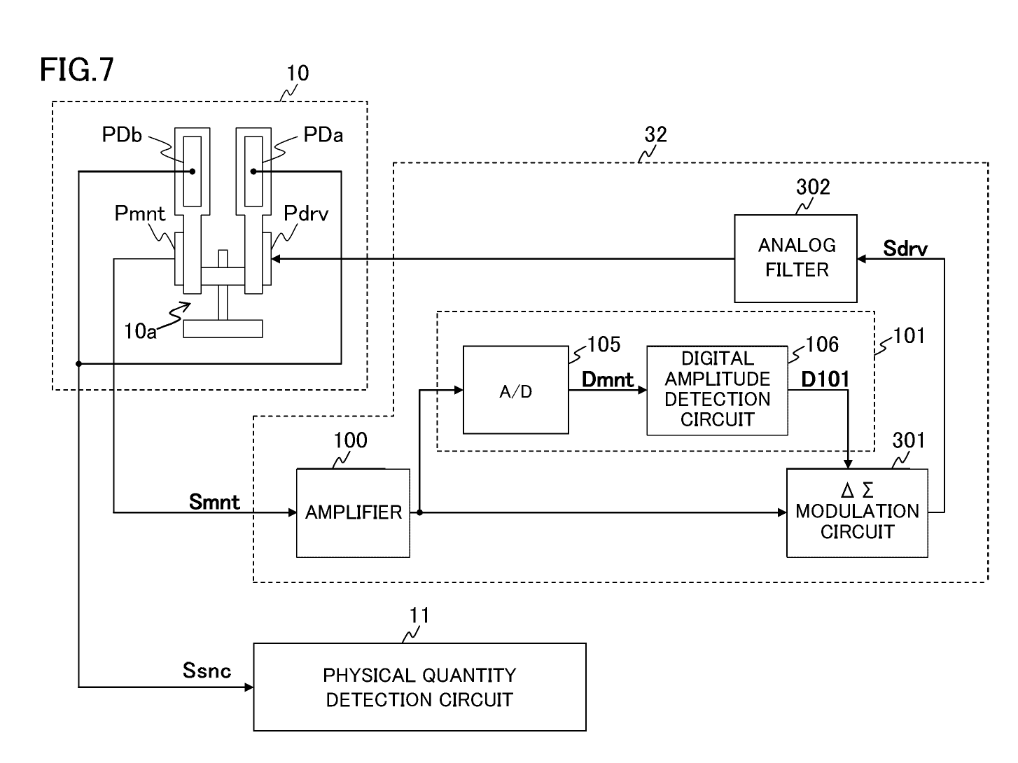

FIG. 7 shows an example configuration of a physical quantity sensor device of the third embodiment. This physical quantity sensor device is the same in configuration as that of FIG. 1 except that a ΔΣ modulation circuit 301 and an analog filter 302 are provided in place of the waveform shaping circuit 102, the phase adjustment circuit 103, and the PAM 104 shown in FIG. 1. The ΔΣ modulation circuit 301 performs ΔΣ modulation on the monitor signal Smnt and outputs the result as the drive signal Sdrv. The input gain of the ΔΣ modulation circuit 301 varies with the amplitude value D101. That is, the ΔΣ modulation circuit 301 practically receives the monitor signal Smnt amplified or attenuated according to the input gain. The analog filter 302 allows a specific frequency component (e.g., a component near the fundamental frequency) of the drive signal Sdrv to pass therethrough while attenuating the other frequency components. In this way, the waveform of the drive signal Sdrv can be brought close to a sine wave. The analog filter 302 is constituted by a band-pass filter, for example.

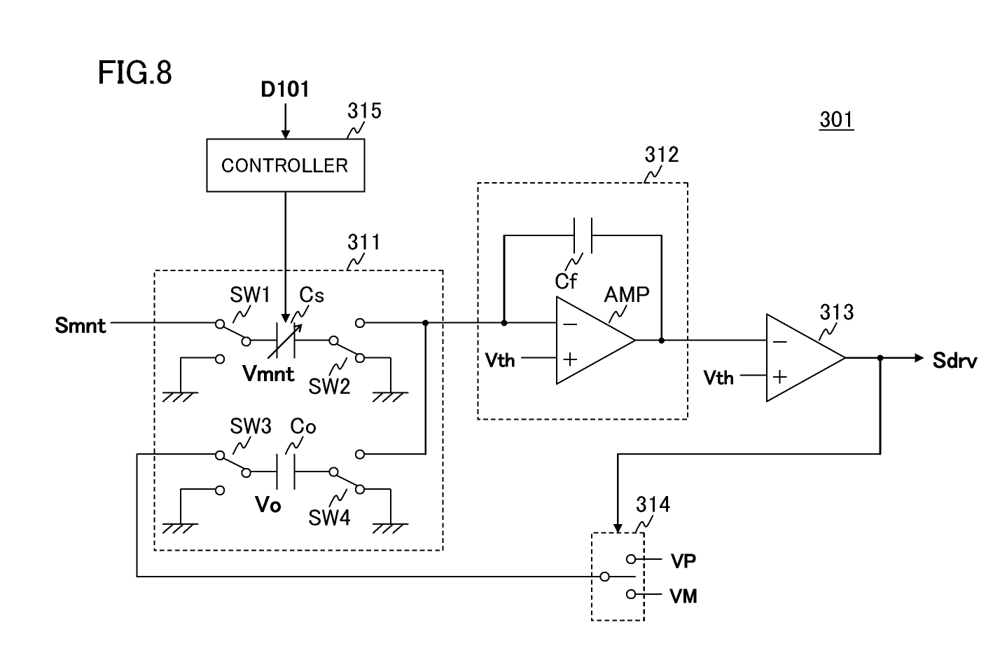

As shown in FIG. 8, the ΔΣ modulation circuit 301 includes: an operation section 311 having sampling capacitors Cs and Co and switches SW1, SW2, SW3, and SW4; an integrator 312 having an operational amplifier AMP and a feedback capacitor Cf; a comparator 313; a selector 314; and a controller 315. The sampling capacitor Cs in this embodiment is a variable capacitor.

In the operation section 311, the switch SW1 supplies the monitor signal Smnt to one terminal of the sampling capacitor Cs, and the switch SW2 couples the other terminal of the sampling capacitor Cs to a ground node. The switch SW3 supplies the output of the selector 314 (a reference voltage VP or VM) to one terminal of the sampling capacitor Co, and the switch SW4 couples the other terminal of the sampling capacitor Co to a ground node. In this switched state, the operation section 311 samples the monitor signal Smnt and holds a sampled voltage in the sampling capacitor Cs as a monitor voltage Vmnt, and also samples the output of the selector 314 and holds a sampled voltage in the sampling capacitor Co as an operation voltage Vo. It is assumed in this embodiment that the reference voltage Vp is higher than a threshold voltage Vth and the reference voltage VM is lower than the threshold voltage Vth. Thereafter, the switch SW1 couples one terminal of the sampling capacitor Co to a ground node, and the switch SW2 couples the other terminal of the sampling capacitor Cs to the integrator 312. The switch SW3 couples one terminal of the sampling capacitor Co to a ground node, and the switch SW4 couples the other terminal of the sampling capacitor Co to the integrator 312. In this switched state, the operation section 311 adds the operation voltage Vo to the monitor voltage Vmnt and outputs the added result (the combined voltage of the monitor voltage Vmnt and the operation voltage Vo) to the integrator 312.

The integrator 312 integrates the output of the operation section 311. The comparator 313 compares the output of the integrator 312 with a threshold voltage Vth (e.g., the ground voltage) to digitize the output of the integrator 312 and outputs the result as the drive signal Sdrv. The selector 314 selects one of the reference voltages VP and VM according to the output of the comparator 313 and outputs the selected one to the operation section 311. The selector 314 selects the reference voltage VM lower than the threshold voltage Vth if the output of the comparator 313 is high, or selects the reference voltage VP higher than the threshold voltage Vth if it is low. In the ΔΣ modulation circuit 301, the pulse density of the drive signal Sdrv changes with increase/decrease in the level of the monitor signal Smnt. For example, the larger the increase in the level of the monitor signal Smnt per unit time, the higher the frequency of occurrence of the high level of the drive signal Sdrv becomes. Similarly, the larger the decrease in the level of the monitor signal Smnt per unit time, the higher the frequency of occurrence of the low level of the drive signal Sdrv becomes.

The controller 315 sets the capacitance value of the sampling capacitor Cs according to the amplitude value D101 in such a manner that the smaller the amplitude value D101, the larger the capacitance ratio of the sampling capacitor Cs to the feedback capacitor Cf (Cs/Cf) is. The larger the capacitance ratio (Cs/Cf), the larger the input gain of the ΔΣ modulation circuit 301 becomes. With increase in the input gain, the transient time (the time during which the signal level transitions comparatively frequently) of the drive signal Sdrv becomes short, and the high-level stable time (the time during which the frequency of occurrence of the high level is comparatively high) and the low-level stable time (the time during which the frequency of occurrence of the low level is comparatively high) become long. The longer the high-level stable time and the low-level stable time, the higher the vibration velocity of the physical quantity sensor 10 becomes, and as a result, the larger the amplitude of the monitor signal Smnt becomes. In this way, the ΔΣ modulation circuit 301 controls the input gain so that the amplitude of the monitor signal Smnt is kept constant.

Also, in the ΔΣ modulation circuit 301, noise is less likely to occur due to fluctuations in power supply voltage and changes in temperature than in the gain control circuit constituted by an analog circuit. This permits correct control of the pulse density of the drive signal Sdrv. The drive signal Sdrv, which is a ΔΣ-modulated signal, has noise components concentrated in a high frequency band higher than the reference frequency (i.e., has been noise-shaped). However, with the frequency response characteristic of the physical quantity sensor 10, it is possible to suppress or reduce fluctuations in the vibration velocity of the physical quantity sensor 10 due to the noise components in the high frequency band.

As described above, by using the pulse-density modulated signal generated by the ΔΣ modulation circuit 301 as the drive signal Sdrv, it is possible to suppress or reduce fluctuations in the vibration velocity of the physical quantity sensor 10 due to fluctuations in power supply voltage and changes in temperature. Thus, the detection precision of the physical quantity sensor 10 can be stabilized.

In addition, since the ΔΣ modulation circuit 301 has a gain adjustment function, it is unnecessary to provide a circuit for amplifying or attenuating the monitor signal Smnt (e.g., a multiplier that multiplies the monitor signal Smnt by a correction amount corresponding to the amplitude value D101) at a stage preceding the ΔΣ modulation circuit 301. Thus, the drive circuit can be simplified in configuration and reduced in circuit scale.

Moreover, with the analog filter 302 allowing a specific frequency component to pass therethrough, it is possible to suppress or reduce fluctuations in the vibration velocity of the physical quantity sensor 10 due to an unnecessary frequency component (e.g., a noise component in a high frequency band). Thus, the detection precision of the physical quantity sensor 10 can be further stabilized.

The phase adjustment circuit 103 may be placed at a stage subsequent to the ΔΣ modulation circuit 301 to ensure synchronization between the monitor signal Smnt and the drive signal Sdrv. Otherwise, the phase of the drive signal Sdrv may be adjusted using the phase characteristic of the analog filter 302.

Not only the sampling capacitor Cs, but also the sampling capacitor Co and the feedback capacitor Cf may be constituted by a variable capacitor. In other words, the input gain of the ΔΣ modulation circuit 301 can be adjusted by adjusting the capacitance value of at least one of the sampling capacitors Cs and Co and the feedback capacitor Cf. For example, the input gain of the ΔΣ modulation circuit 301 can be increased by reducing the capacitance ratio of the sampling capacitor Co to the sampling capacitor Cs (Co/Cs).

(Variations of Amplitude Detection Circuit)

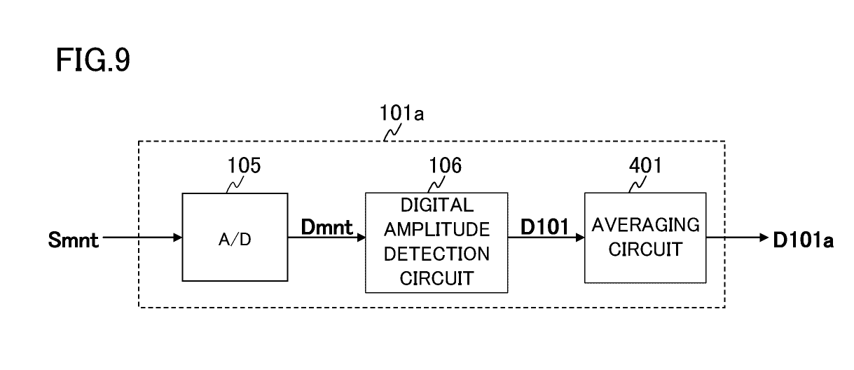

In the above embodiments, the drive circuits 12, 22, and 32 may include an amplitude detection circuit 101a shown in FIG. 9 in place of the amplitude detection circuit 101. The amplitude detection circuit 101a includes an averaging circuit 401 in addition to the components of the amplitude detection circuit 101 shown in FIG. 1. The averaging circuit 401 averages a plurality of amplitude values D101, D101, . . . obtained by the digital amplitude detection circuit 106 and outputs the resultant average value D101a. The PAM 104, the PWM 204, and the ΔΣ modulation circuit 301 control the drive signal Sdrv according to the average value D101a. If frequency jitter is occurring in the monitor signal Smnt due to self-excited vibration of the physical quantity sensor 10, the sampling points of the monitor signal Smnt may vary in the A/D 105, causing variations in the amplitude value D101 obtained by the digital amplitude detection circuit 106 even when the amplitude of the monitor signal Smnt is constant. By averaging the plurality of amplitude values D101, D101, . . . by the averaging circuit 401, variations in the amplitude value D101 due to frequency jitter in the monitor signal Smnt can be suppressed or reduced. This permits correct control of the drive signal Sdrv, and thus the vibration velocity of the physical quantity sensor 10 can be further stabilized.

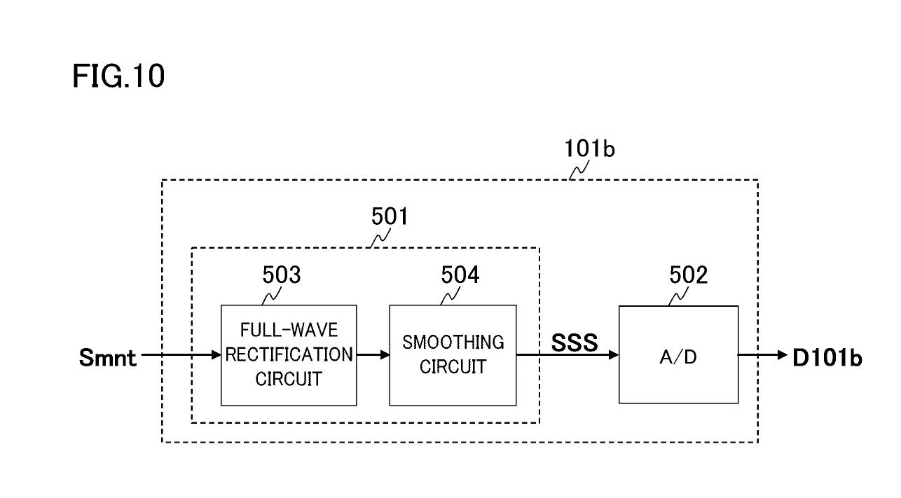

The drive circuits 12, 22, and 32 may otherwise include an amplitude detection circuit 101b shown in FIG. 10 in place of the amplitude detection circuit 101. The amplitude detection circuit 101b includes an analog amplitude detection circuit 501 and an analog-to-digital conversion circuit (A/D) 502. The analog amplitude detection circuit 501, which detects the amplitude value SSS (analog value) of the monitor signal Smnt, includes a full-wave rectification circuit 503 that full-wave rectifies the monitor signal Smnt and a smoothing circuit 504 that smoothes the output of the full-wave rectification circuit 503 and outputs the result as the amplitude value SSS, for example. The A/D 502 converts the amplitude value SSS (analog value) to an amplitude value D101b (digital value). The PAM 104, the PWM 204, and the ΔΣ modulation circuit 301 control the drive signal Sdrv according to the amplitude value D101b.

(Sampling Frequency)

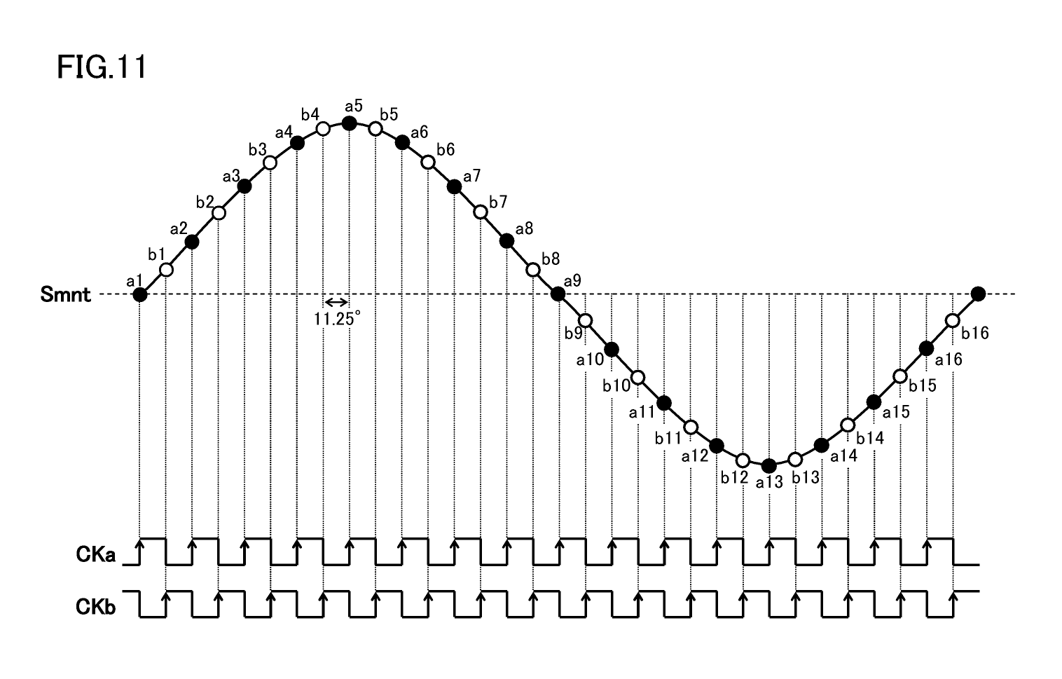

In the amplitude detection circuit 101, the higher the sampling frequency of the A/D 105, the more correct detection of the amplitude value of the monitor signal Smnt can be ensured. In particular, it is preferred to set the sampling frequency of the A/D 105 to be 16 times or more the frequency of the monitor signal Smnt. The reason for this is as follows. Referring to FIG. 11, clocks CKa and CKb have a frequency 16 times that of the monitor signal Smnt, where the clock CKa corresponds to an ideal sampling clock synchronizing with the monitor signal Smnt and the clock CKb corresponds to a sampling clock of which the phase difference from the monitor signal Smnt is maximum (11.25° in the illustrated example). For a sampling clock synchronizing with the monitor signal Smnt (i.e., the clock CKa), the monitor signal Smnt is converted to digital values a1, a2, . . . , a16. Digital values a5 and a13 respectively correspond to the maximum and minimum values of the monitor signal Smnt. For a sampling clock of which the phase difference from the monitor signal Smnt is maximum (i.e., the clock CKb), the monitor signal Smnt is converted to digital values b1, b2, . . . , b16. In this case, while digital values b4 and b5 are maximum among the digital values b1, b2, . . . , b16, they do not correspond to the maximum value of the monitor signal Smnt. Similarly, while digital values b12 and b13 are minimum among the digital values b1, b2, . . . , b16, they do not correspond to the minimum value of the monitor signal Smnt. An amplitude detection error “X” is expressed by:

$$\begin{matrix}X = ( a 5 - b 4 ) / a 5 \\ = \{ A sin 90 ° - A sin ( 90 ° - 11.25 ° ) \} / A sin {90}^{∘} \\ = 1 - sin ( 90 ° - 11.25 ° ) \approx 0.0192\end{matrix}$$

where “A” is the amplitude of the monitor signal Smnt.

As described above, by setting the sampling frequency to be 16 times or more the frequency of the monitor signal Smnt, the amplitude detection error can be as small as less than 2%. Thus, by setting a high sampling frequency for the analog-to-digital conversion circuit, it is possible to suppress or reduce fluctuations in the vibration velocity of the physical quantity sensor 10 due to a shift of the sampling timing. The sampling clock may be generated using the monitor signal Smnt as the frequency reference. For example, the sampling clock may be generated by multiplying the output of the waveform shaping circuit 102 (the pulse signal P102). This facilitates generation of the sampling clock synchronizing with the monitor signal Smnt.

(Variation of Phase Adjustment Circuit)

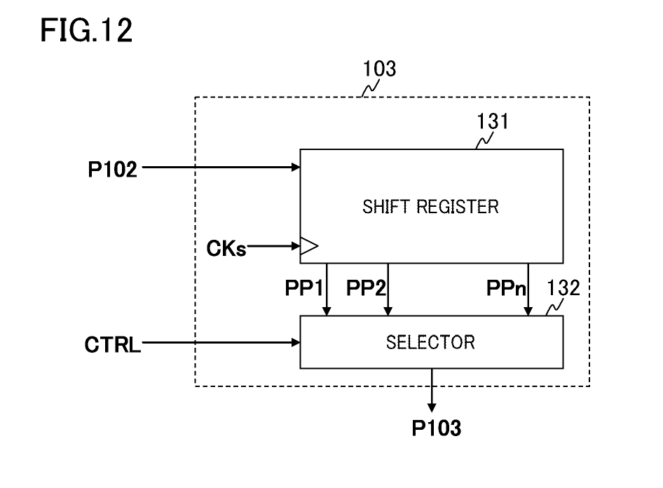

The phase adjustment amount of the phase adjustment circuit 103 may be variable. For example, as shown in FIG. 12, the phase adjustment circuit 103 may include a shift register 131 and a selector 132. The shift register 131 shifts the pulse signal P102 sequentially in synchronization with a clock CKs (e.g., a clock having a frequency higher than the monitor signal Smnt), thereby to generate n pulse signals PP1, PP2, . . . , PPn different in phase from one another. The selector 132 selects one of the pulse signals PP1, PP2, . . . , PPn as the pulse signal P103 in response to external control CTRL. With this configuration, the phase of the pulse signal P102 can be adjusted correctly using the period of the clock CKs as the unit. The clock CKs may be generated using the monitor signal Smnt as the frequency reference, or the sampling clock of the A/C 105 may be used as the clock CKs.

(Variations of Physical Quantity Sensor)

The physical quantity sensor 10 does not have to be of the tuning fork type, but may be of a circular cylinder type, a regular triangular prism type, a square prism type, or a ring type, or may be of another shape.

As described above, the drive circuit of the present disclosure, which can stabilize the detection precision of physical quantity sensors, is suitable for physical quantity sensors used in mobile units, cellular phones, digital cameras, game machines, etc.

It should be noted that the embodiments described above are essentially preferred illustrations and by no means intended to restrict the scope of the present invention, applications thereof, or uses thereof.

What is claimed is:

1. A drive circuit configured to drive a physical quantity sensor that vibrates from self-excitation by application of a drive signal to output a monitor signal responsive to the self-excited vibration and also output a sensor signal according to a physical quantity given externally, the drive circuit comprising:
an amplitude detection circuit configured to detect an amplitude value of the monitor signal;
a waveform shaping circuit configured to convert the monitor signal to a pulse signal; and
a pulse modulation circuit configured to adjust an amplitude of the pulse signal according to the amplitude value obtained by the amplitude detection circuit and output the result as the drive signal.

2. A drive circuit configured to drive a physical quantity sensor that vibrates from self-excitation by application of a drive signal to output a monitor signal responsive to the self-excited vibration and also output a sensor signal according to a physical quantity given externally, the drive circuit comprising:
an amplitude detection circuit configured to detect an amplitude value of the monitor signal; and
a ΔΣ modulation circuit having an input gain variable according to the amplitude value obtained by the amplitude detection circuit, configured to perform ΔΣ-modulation on the monitor signal and output the result as the drive signal.

3. The drive circuit of claim 2, further comprising:
an analog filter configured to allow a specific frequency component of the drive signal output from the ΔΣ modulation circuit to pass therethrough.

4. The drive circuit of claim 2, wherein
the ΔΣ modulation circuit includes
an operation section having first and second sampling capacitors, configured to sample the monitor signal and hold the result in the first sampling capacitor as a monitor voltage, while sampling one of first and second reference voltages and holding the result in the second sampling capacitor as an operation voltage, and add the operation voltage to the monitor voltage,
an integrator having an operational amplifier and a feedback capacitor, configured to integrate the output of the operation section,
a comparator configured to digitize the output of the integrator,
a selector configured to supply one of the first and second reference voltages to the operation section according to the output of the comparator for sampling, and
a controller configured to adjust a capacitance value of at least one capacitor among the first and second sampling capacitors and the feedback capacitor according to the amplitude value obtained by the amplitude detection circuit.

5. The drive circuit of claim 1, wherein
the amplitude detection circuit includes
an analog-to-digital conversion circuit configured to convert the monitor signal to a digital monitor signal, and
a digital amplitude detection circuit configured to detect an amplitude value of the digital monitor signal obtained by the analog-to-digital conversion circuit.

6. The drive circuit of claim 1, wherein
the amplitude detection circuit includes
an analog-to-digital conversion circuit configured to convert the monitor signal to a digital monitor signal,
a digital amplitude detection circuit configured to repeat the processing of detecting an amplitude value of the digital monitor signal obtained by the analog-to-digital conversion circuit, and
an averaging circuit configured to average a plurality of amplitude values obtained by the digital amplitude detection circuit.

7. The drive circuit of claim 5, wherein
the sampling frequency of the analog-to-digital conversion circuit is 16 times or more the frequency of the monitor signal.

8. The drive circuit of claim 6, wherein
the sampling frequency of the analog-to-digital conversion circuit is 16 times or more the frequency of the monitor signal.

9. The drive circuit of claim 1, wherein
the amplitude detection circuit includes
an analog amplitude detection circuit configured to detect an amplitude value of the monitor signal, and
an analog-to-digital conversion circuit configured to convert the amplitude value obtained by the analog amplitude detection circuit to a digital value.

10. A physical quantity sensor device comprising:
a physical quantity sensor configured to vibrate from self-excitation by application of a drive signal to output a monitor signal responsive to the self-excited vibration and also output a sensor signal according to a physical quantity given externally;
the drive circuit of claim 1; and
a physical quantity detection circuit configured to detect the physical quantity based on the sensor signal.
